(19) United States
(12) Patent Application Publication
(10) Pub. No.: US 2023/0173414 A1
(43) Pub. Date: Jun. 8, 2023

(54) SYSTEM FOR SEPARATING SUSPENDED SUBSTANCES FROM A LIQUID USING A CYCLONE FILTER-TYPE ASSEMBLY

(71) Applicant: Georg KLAß, JR., Türkenfeld (DE)

(72) Inventor: Georg KLAß, JR., Türkenfeld (DE)

(21) Appl. No.: 17/912,538

(22) PCT Filed: Mar. 22, 2021
(86) PCT No.: PCT/EP2021/057250

§ 371 Date: Sep. 19, 2022

(30) Foreign Application Priority Data
Mar. 23, 2020 (DE) 10 2020 203 699.3

(51) Int. Cl. B01D 29/11; B01D 29/60; B01D 29/90

(52) U.S. Cl. CPC B01D 29/114; B01D 29/606; B01D 29/908

(57) ABSTRACT

A system which separates suspended substances from a liquid with a cyclone filter assembly that is rotationable symmetrically about a longitudinal axis. The invention is has a filter element with a filter wall configured as a single-layered perforated sheet with perforation holes having a hole diameter ranging from 5 µm to 80 µm inclusive at a radially outer filter wall surface with sensors for measuring a pressure difference between the filtrate chamber and a separation. A respective shut-off valve is located along first and second discharge lines, and a control actuates at least one of motor and at least one shut-off valve as a function of the pressure difference.

### CROSS-REFERENCE TO RELATED APPLICATIONS

Reference is made to International Application No. PCT/EP2021/057250, filed Mar. 22, 2021, which claims priority to German Patent Application No. 10 2020 203 699.3, filed Mar. 23, 2020, the contents of which are incorporated herein by reference in their entirety.

### BACKGROUND OF THE INVENTION

### Field of the Invention

The invention relates to a system for separating suspended substances from a liquid, with a filter assembly of the cyclone filter type with a filter housing which is rotationally symmetrical about a longitudinal axis, which comprises a filter element disposed centrally to the longitudinal axis and which is also a hollow cylinder which radially surrounds an inner cylindrical filtrate chamber and which delimits a flow channel annular in cross section, which has a swirl chamber into which a flow feed line opens eccentrically and transversely to the longitudinal axis, as well as having a separating channel which is connected along the longitudinal axis indirectly or directly downstream of the swirl chamber, as well as with a flow guide surface assembly which has at least one flow guide surface element extending parallel to the longitudinal axis, disposed radially separated from the filter element, and inside the flow channel, and which is rotatably mounted about the longitudinal axis and can be driven by a rotary motor, wherein the filtrate chamber is connected to a first discharge line and the separating channel is connected to a second discharge line.

### Description of the Prior Art

Filter assemblies which are configured as centrifugal separators (which are also often referred to as cyclone filters) exploit the separating action of centrifugal force acting on particles of solid substances contained in a gaseous or liquid swirled flow. In order to produce the swirled flow, a rotationally symmetrically configured filter housing which is substantially tubular in configuration is used and having a flow feed line which is laterally eccentric with respect to its longitudinal axis, through which the medium to be filtered is introduced, with the formation of a swirled flow orientated around the longitudinal axis. Central to the longitudinal axis, a tubular filter element is installed inside the filter housing and is usually in fluid communication with a low pressure flow discharge line. The separation of particles of solid substance contained in the gaseous or liquid medium which is driven by centrifugal force results in the particles being collected in the region of the filter housing wall radially surrounding the filter element along which the particles collect fluid dynamically and are removed when necessary. In contrast, the flow regions for the swirled flow, which flows directly around the filter wall of the centrally disposed tubular filter element, are extensively cleaned and in any case contain lightweight particles of solid substances which should be prevented from passing through the filter wall into the interior of the filter element. To this end, the sieve size of the filter wall is selected in a suitable manner so that the desired filtration action and on the other hand a sufficient passage of flow through the filter wall into the interior of the filter element is obtained in order to produce a cleaned filtered mass flow.

The publication EP 2 049 222 B1 discloses a filter device of the aforementioned type for separating contaminants from a fluid stream by the use of a filter element which is accommodated in a filter housing, wherein the filter housing has a swirl chamber in a manner such that at least a portion of the fluid stream to be filtered is guided around the filter element in a swirled flow. A feed line opens eccentrically to the longitudinal axis into the swirl chamber formed as a conical widening of the filter housing through which the medium to be filtered is fed. The filter element, which extends along the filter housing, tapers conically with increasing distance from the swirl chamber and in the region of the swirl chamber is connected in a fluid-tight manner to the discharge line for the filtered medium from the interior of the filter element.

The mode of operation of centrifugal force separators that are known per se employs a pressurized fluid flow to be filtered which opens into the swirl chamber of the filter housing and which flows helically over the elongated tubular filter element with the formation of a swirled flow and passes through it radially under pressure from outside through the filter wall into the interior of the filter element, cleaning out particles of solid substances. The purified filtrate flow therefore passes out of the interior of the filter element under pressure via the discharge line.

U.S. Published application 2005/0040091 describes a filter assembly of the cyclone filter type with the filter element thereof having filter holes in the shape of annular gaps inside the filter element which is otherwise configured in the form of a hollow cylinder. In order to clean the filter element, a backwash through the filter assembly is employed which for this requires the operation of the filter to be interrupted.

U.S. Published application 2014/0034568 discloses a gear pump (known as a trochoid pump,) which is combined with a filter element as a hollow cylinder combined with a surrounding scoop assembly to safeguard the filter element from clogging the filter.

Systemic filter residues adhering in and on the wall of the filter element lead to deterioration of the efficiency of the filter and make it necessary to carry out frequent filter cleaning procedures. An example of this is backwashing the filter assembly with a medium.

In the interests of a robust and long-lasting operation of cyclone filters of this type, filter elements installed in assemblies of this type have filter hole sizes with a minimum hole diameter of 100 µm.

### SUMMARY OF THE INVENTION

The invention is a further developed system for separating suspended substances from a liquid, with a filter assembly of the cyclone filter type with a filter housing which is rotationally symmetrical about a longitudinal axis, comprising a filter element disposed centrally to the longitudinal axis which a hollow cylinder which radially surrounds an inner cylindrical filtrate chamber that delimits an annular flow channel which has a swirl chamber into which a flow feed line opens eccentrically and transversely to the longitudinal axis, a separating channel which is connected along the longitudinal axis (indirectly or directly) downstream of the swirl chamber, a flow guide surface assembly having at least one flow guide surface element extending parallel to the longitudinal axis, is disposed radially separated from the filter element, inside the flow channel, and which is rotatably mounted about the longitudinal axis permitted being driven by a rotary motor, wherein the filtrate chamber is connected to a first discharge line and the separating channel is connected to a second discharge line so that cleaning of liquid mixed with particles of solid wherein the dimensions of the particles are smaller than 100 µm becomes possible. The operation of a system of this type is capable of operation in a manner which is robust and free from interruptions, as is the case in known systems for cleaning waste water containing macroscopic solids.

A system in accordance with the invention for separating suspended substances from a liquid with a filter assembly of the cyclone filter type is characterized by the filter element having a filter wall configured as a single-layered perforated sheet with the perforation holes having a largest hole diameter ranging from 5 µm to 80 µm inclusive at the radially outer filter wall surface, with measurement of a pressure difference between the filtrate chamber and the separating channel being provided, in that a shut-off valve is introduced along the first and the second discharge line, and in that a control unit is provided which actuates at least one of the rotary motor and at least one of the shut-off valves as a function of the pressure difference.

The system in accordance with the invention enables solid particles with particle sizes significantly below 100 µm to be separated from liquid media, preferably in the form of waste water. The filter element disposed in the cyclone filter for this purpose has a straight cylindrically shaped filter wall with a radially outwardly orientated as well as a radially inwardly orientated filter wall surface through which multiple perforation holes pass completely. In the case of the cylindrical perforation holes passing through the filter wall, the largest hole diameters are in the range from 5 µm to 80 µm inclusive. In the case of perforation holes passing through the filter wall with a conically widening hole geometry, the respective smallest hole diameter of the perforation holes, also in the range from 5 µm to 80 µm, is disposed on the radially outwardly orientated filter wall surface.

As an alternative or in combination, the perforation holes may have a slit-shaped hole diameter at the radially outer filter wall surface, respectively with a slit length 1 and a slit width b, in which: 5 µm ≤ 1, b ≤ 80 µm.

Hole diameters of this kind of small size would rapidly clog in conventional cyclone filters and those in operation until now that is solid particles would stick to the surface on the radially outwardly orientated filter wall surface in the region of the hole openings, which would at least result in significantly compromising the filtration efficiency, culminating in the complete failure of the cyclone filter. As a result, time-consuming and labor-intensive filter cleaning procedures would be inevitable.

In order to prevent the aforementioned blockage of the filters, the cyclone filter in the system in accordance with the invention is provided with at least one flow guide surface element moved over the radially outwardly orientated filter wall surface close to the surface and which is rotatably disposed about the longitudinal axis of the cylindrical filter element and which has a length corresponding to at least the dimension of the longitudinal extent of the filter element. By use of the rotational dynamics of a preferably wing-profiled flow guide surface element, an underpressure is generated in accordance with Bernoulli’s theorem in the rotation gap between the outer filter element wall and the flow guide surface element, which preferably has a constant gap width ranging between 1 and 10 mm, with the suction effect thereof causes solid particles that might be sticking to the outer filter element wall to be literally torn away from the filter wall.

In addition, precautions are taken to ensure that the cyclone filter is always completely filled with liquid that is the swirl chamber and the separating channel are filled with the liquid mixed with solid particles and which is to be cleaned and the filtrate chamber is filled with the liquid which has been at least substantially freed from the solid particles, what is known as the clean liquid, in order to be able to exploit the aforementioned cleaning effect based on a dynamic suction effect. In order to be able to implement this as simply as possible, a discharge line which is connected to the separating channel, hereinafter designated the first discharge line, along which the waste liquid is discharged, as well as a second discharge line which is connected to the filtrate chamber, via which the clean liquid is discharged, which are respectively disposed to run vertically above the filling level for the cyclone filter.

Alternatively or in combination with the aforementioned layout, a monitoring unit is provided which detects filling of the cyclone filter with liquid by using sensors, in which at least the filter element is completely surrounded by liquid.

During the course of many tests which were carried out, it has been established that for successful operation of the cyclone filter with a filter element which has perforation holes with the aforementioned hole dimensions, a pressure difference must be obtained between the lower filtrate chamber pressure and the higher separating channel pressure which should not exceed 200 mbar and preferably 100 mbar, otherwise the cleaning effect brought about by the suction action comes to a standstill. In the case of a higher pressure difference, the adhesion forces, which are also pressure-dependent, with which the solids stick to the radially outer filter element wall and therefore clog the perforation holes, predominate against the hydrodynamic suction based cleaning forces which are developing. For this reason, the system in accordance with the invention is provided with measurement of the pressure difference between the filtrate chamber and the separating channel, as well as a control unit which actuates at least one of the rotary motor and at least one of the shut-off valves as a function of the pressure difference. The shut-off valves, which are preferably configured as throttle valves, may be adjusted steplessly so that fine-tuning of the pressure difference is possible in this manner. In addition to activation of the rotary motor, in the context of simply switching the rotary motor on and off, in a preferred embodiment the control unit can also act on the speed of rotation of the rotary motor and therefore on the suction action caused by it between the at least one wing-profiled flow guide surface element and the outer wall surface of the filter element.

The rotary motor, which constitutes a highly relevant cost factor during operation of the system, can be operated in this way in regular operation as a function of the degree of contamination of the liquid mixed with solid particles which is to be cleaned. In this manner, the operating costs for the system’s energy can be reduced and individually adjusted to the actual cleaning requirement.

The apparatus for measuring the pressure difference preferably respectively have a pressure sensor in the first and second discharge lines, along which are disposed, in addition, a respective shut-off valve, preferably in the form of a continuous completely closable throttle valve. In this manner, the quantities of waste or clean liquids discharged through the respective discharge lines can be automatically or manually adjusted.

Preferably, the cyclone filter is pressurized with the liquid from which the suspended materials are to be separated by a pressure source disposed along the flow feed line opening into the swirl chamber in a manner such that a helical flow orientated around the longitudinal axis is produced inside the separating channel with a direction of flow prescribed by the swirl chamber and a flow rate determined by the pressure source. Preferably, the pressure source is also controlled or regulated with the aid of the control unit.

From a fluid mechanics viewpoint, the filter element constitutes a throttle element through which, with no further measures, upon filling the cyclone filter at a prescribed pressure, a pressure difference is generated between the separating channel and the filtrate chamber. With the aid of the shut-off valves or throttle valves disposed in the first and second discharge lines, the pressure difference between the filtrate chamber and the separating channel can be manipulated directly.

As an alternative or in combination with the actuation of the shut-off valves or throttle valves, in a further preferred embodiment of the system, a respective suction unit is provided in at least one of the first and second discharge line, through which the output with respect of the waste and/or clean liquid can be manipulated separately from each other or in combination.

In order to manipulate the pressure difference between the separating channel and the filtrate chamber, in a further preferred embodiment of the system, the control unit controls at least one of the following components as described above which are a rotary motor, a pressure source along the flow feed line, a shut-off valve or throttle valve along the first and second discharge lines, as well as the suction unit along the first and second discharge lines.

### BRIEF DESCRIPTION OF THE DRAWINGS

The invention will now be described by way of example, without limitation to the general inventive concept, with the aid of an exemplary embodiment and with reference to the drawing, in which:

FIG. 1 shows a diagrammatic system with a cyclone filter

### WAYS OF CARRYING OUT THE INVENTION; INDUSTRIAL APPLICABILITY

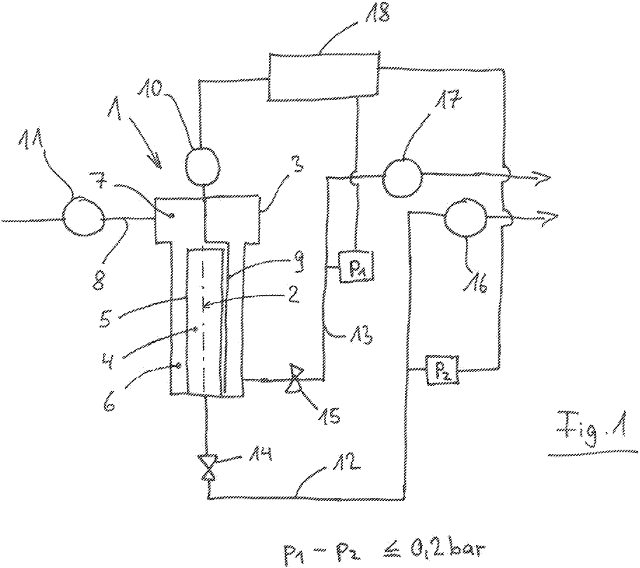

FIG. 1 shows a system for separating suspended substances from a liquid, with a filter assembly 1 of the cyclone filter type with a filter housing 3 which is rotationally symmetrical about a longitudinal axis 2, which comprises a filter element 5 disposed centrally to the longitudinal axis 2 and which is also a hollow cylinder radially surrounding an inner cylindrical filtrate chamber 4 which delimits a flow channel which is annular in cross section, which has a swirl chamber 7 into which a flow feed line 8 opens eccentrically and transversely to the longitudinal axis 2, as well as having a separating channel 6 which is connected along the longitudinal axis 2 indirectly or directly downstream of the swirl chamber 7, as well as with a flow guide surface assembly which has at least one flow guide surface element 9 which extends parallel to the longitudinal axis 2 that is disposed radially separated from the filter element 5 and inside the separating channel 6, and which is rotatably mounted about the longitudinal axis 2 which can be driven by a rotary motor 10.

The filter element 5 has a filter wall configured as a single-layered perforated sheet with the perforation holes having a largest hole diameter ranging from 5 µm to 80 µm inclusive at the radially outer filter wall surface.

A pressure source 11 is disposed upstream of the flow feed line 8, which liquid flows containing materials which are to be separated enters the swirl chamber 7 of the cyclone filter 1 under pressure, so that inside the separating channel 6, a helical flow is generated which is orientated around the longitudinal axis 2 in a direction of flow prescribed by the swirl chamber 7 and a flow rate determined by the pressure source 11.

The separating channel 6 is in fluid communication with the first discharge line 13 and the filtrate chamber 4 is in fluid communication with the second discharge line 12. At least one pressure sensor p1, p2 as well as at least one shut-off valve or throttle valve 14, 15 are respectively disposed along the first and second discharge lines 13, 12. In addition, a first suction apparatus 17 is disposed along the first discharge line 13 and a second suction unit 16 is disposed along the second discharge line 12.

The pressure difference between the filtrate chamber 4 and the separating channel 6 can be measured with pressure sensors p1, p2. Both pressure sensors p1, p2 are connected to a control unit 18 which activates the rotary motor 10, manipulates its speed of rotation, and controls the throttle valves 14, 15, the pressure source, and the first/second suction apparatus 16, 17 as a function of the pressure difference Δp = p1-p2. The control of at least one of the aforementioned components is carried out on the requirement that the pressure difference Δp must be kept below 0.2 bar, which preferably is below 100mbar.

The system shown in FIG. 1 enables operation as a function of the degree of contamination of the liquid contaminated with solid particles. If, for example, the liquids are only slightly contaminated, then the shut-off valve/throttle valve 15 can be closed and the rotary motor 15 switched off. If the pressure along the first discharge line 13 drops, then this is an indication of the start of clogging or blockage of the filter element 5. As a consequence of this, at least one of the rotary motor 10 being activated and the shut-off valve 15 being opened can be performed.

List of reference numerals

| | |
|---|---|
| 1 | cyclone filter |
| 2 | longitudinal axis |
| 3 | filter housing |
| 4 | filtrate chamber |
| 5 | filter element |
| 6 | separating channel |
| 7 | swirl chamber |
| 8 | flow feed line |
| 9 | flow guide surface element |
| 10 | rotary motor |
| 11 | pressure source |
| 12 | first discharge line |
| 13 | second discharge line |
| 14 | first shut-off valve/throttle valve |
| 15 | second shut-off valve/throttle valve |
| 16 | first suction unit or apparatus |
| 17 | second suction unit or apparatus |
| 18 | control unit/apparatus |
| p1 | pressure sensor |
| p2 | pressure sensor |

1-13. (canceled)

14. A system for separating suspended substances from a liquid comprising:
a cyclone filter assembly including a filter housing which is rotationablesymmetrically about a longitudinal axis;
a filter element disposed centrally about the longitudinal axis havng a filter wall configured as a perforated sheet including holes having a largest dimension ranging from 5 µ to 80 µ, a radially extending outer filter wall defining a hollow cylinder radially surrounding a filtrate chamber delimiting a flow channel having an annular cross section and including a swirl chamber into which a flow feed line opens which is mounted eccentrically by and transversely to the longitudinal axis, and a separation channel connected downstream from the swirl chamber;
a flow guide including at least one flow guide element extending parallel to the longitudinal axis, radially separated from the filter element and inside the separation channel and is mounted to rotate about the longitudinal axis and is connected to a first discharge line and the separation channel is connected to a second discharge line;
means for measuring a pressure difference between the filtrate chamber and the separation channel;
shut-off valves respectively disposed in the first and second discharge lines; and
a control for actuating at least one of the motor and at least one of the shut-off valves as a function of the pressure difference.

15. The system as claimed in claim 14, wherein the holes have a constant hole diameter.

16. The system as claimed in claim 14, wherein the respective holes have a smallest hole diameter at an outer filter wall surface which increases in diameter inwardly into the outer filter wall.

17. The system as claimed in claim 14, comprising:
a monitoring apparatus including liquid sensors for detecting liquid filling of the cyclone filter assembly with at least the filter element being completely surrounded by liquid.

18. The system as claimed in claim 14, wherein the at least one flow guide surface element has a gap ranging from 1 mm to 10 mm.

19. The system as claimed in claim 14, wherein the at least one flow guide surface element rotates inside the at least one filter element, is completely surrounded by liquid and hydrodynamic suction of the liquid acts locally between the at least one flow guide element and a an outer wall of the filter element.

20. The system as claimed in claim 14, comprising:
a pressure source upstream of the flow feed line providing pressurized liquid containing suspended substances to be separated which enters the swirl chamber which inside the separation channel cause helical flow to be orientated around the longitudinal axis which flows in a flow direction in the swirl chamber produced by liquid flow from the pressure source.

21. The system as claimed in claim 14, comprising:
a first suction apparatus disposed in the first discharge line and a second suction apparatus is disposed in the second discharge line.

22. The system as claimed in claim 14, wherein the means for measuring a pressure difference includes at least one pressure sensor respectively located in each of the first and the second discharge lines.

23. The system as claimed in claim 14, wherein the shut-off valves are throttle valves.

24. The system as claimed in claim 14, wherein the holes have a slit dimension at a radially outer filter wall surface having a slit length 1 and a slit width b, for which 5 µm ≤ 1, b ≤ 80 µm.

25. The system as claimed in claim 14, wherein the first and second discharge lines are each disposed vertically above a fill level of liquid filling the cyclone filter element.

26. A method for operating a system as claimed in claim 14,wherein the control maintains a pressure difference between the separation channel and the filtrate chamber equal to or less than 200 mbar upon actuation of at least one of the motor and the shut-off valves along at least one of the first and second discharge line.

27. The system as claimed in claim 15, wherein the holes have a slit dimension at the outer filter wall with a slit length being 1 and a slit width being b, for which 5 µm ≤ 1, b ≤ 80 µm.

28. The system as claimed in claim 16, wherein the holes have a slit dimension at the outer filter wall with a slit length being 1 and a slit width being b, for which 5 µm ≤ 1, b ≤ 80 µm.

29. The system as claimed in claim 17, wherein the holes have a slit-shaped hole dimension at an outer filter wall surface with a slit length 1 and a slit width b, for which 5 µm ≤ 1, b ≤ 80 µm.

30. The system as claimed in claim 15, wherein the holes have a smallest dimension at the outer filter wall.

31. The system as claimed in claim 15, comprising:
a monitoring apparatus including liquid sensors for detecting liquid filling the cyclone filter assembly with at least the filter element being completely surrounded by liquid.

32. The system as claimed in claim 16, comprising:
a monitoring apparatus including liquid sensors for detecting liquid filling the cyclone filter assembly with at least the filter element being completely surrounded by liquid.

33. The system as claimed in claim 17, comprising:
a monitoring apparatus including liquid sensors for detecting liquid filling the cyclone filter assembly with at least the filter element being completely surrounded by liquid.
